(19) United States
(12) Patent Application Publication
(10) Pub. No.: US 2026/0158502 A1
(43) Pub. Date: Jun. 11, 2026

(54) Centrifuge, in particular laboratory centrifuge, method for servicing the centrifuge, and method for manufacturing the centrifuge

(71) Applicant: Eppendorf SE, Hamburg (DE)

(72) Inventors: Christoph KNOSPE, Leipzig (DE); Eric TAUCHNITZ, Taucha (DE); Lars OEHMICHEN, Dresden (DE)

(73) Assignee: Eppendorf SE, Hamburg (DE)

(21) Appl. No.: 19/349,537

(22) Filed: Oct. 3, 2025

(30) Foreign Application Priority Data
Oct. 28, 2024 (DE) 10 2024 131 421.4

(51) Int. Cl. B04B 15/02; B04B 7/02; B04B 9/02; B04B 13/00

(52) U.S. Cl. CPC B04B 15/02; B04B 7/02; B04B 9/02; B04B 13/00; B04B 2007/025

(57) ABSTRACT

A centrifuge, in particular laboratory centrifuge (1; 21), has, in the interior of a centrifuge housing (3), a rotor (7) for receiving and centrifuging centrifuged material. The centrifuge housing (3) has a top side, a bottom side, a front side and a rear side. The centrifuge has an electronic unit (5) with a plurality of electronic components for realizing electronic functions for operation of the centrifuge. The centrifuge is designed in such a way that the electronic unit (5) can be taken out of the centrifuge housing (3) from the front side.

### CROSS-REFERENCE TO RELATED APPLICATION

This application claims the benefit of German Patent Application DE 10 2024 131 421.4, filed on Oct. 28, 2024, the content of which is incorporated by reference.

### TECHNICAL FIELD

The disclosure relates to a centrifuge, to a method for servicing a centrifuge and to a method for producing a centrifuge. The centrifuge is in particular a laboratory centrifuge.

### BACKGROUND

Centrifuges, in particular laboratory centrifuges, are used to separate the component parts of mixtures centrifuged in a container of the laboratory centrifuge by using mass inertia. High rotation speeds occur in the process. Laboratory centrifuges are centrifuges with centrifuge rotors that operate at preferentially at least 3000, preferably at least 10,000, in particular at least 15,000 revolutions per minute and are usually placed on workstations raised up from the floor, e.g. tables. In order to be able to place them on a work table, they have in particular a form factor and/or external dimensions of less than 1 m×1 m×1 m. Their installation space is therefore restricted. With preference, in this case the device depth is restricted to 70 cm maximum. However, laboratory centrifuges are also known which are designed as standing centrifuges and have in particular a height of 1 m to 1.5 m so as to be able to place them on the floor of a room. Laboratory centrifuges are designed in particular for demixing at least one laboratory sample and/or for use in a laboratory.

This laboratory can be in particular a chemical, biological, biochemical, medical, pharmaceutical, food science and/or forensics laboratory. Such laboratories are used to research and/or analyse laboratory samples, but can also be used to produce products by means of laboratory samples or produce laboratory samples.

The containers can be a permanent component part of the laboratory centrifuge or can be temporarily arranged on and/or in the laboratory centrifuge in particular together with a sample for treating and/or generating the sample. The laboratory centrifuge, in particular a treatment device of the laboratory centrifuge, has in particular at least one rotor, on and/or in which the at least one laboratory sample can be arranged. The laboratory centrifuge, in particular the treatment device of the laboratory centrifuge, has at least one drive device, by means of which the rotational movement of the rotor can be driven about an associated axis of rotation. The samples can be arranged in the at least one rotor, in particular in laboratory containers, e.g. test tubes, placed in suitable mounts in the rotor. Preferably, the laboratory centrifuge, in particular the treatment device of the laboratory centrifuge, has at least one heating/cooling device with which the temperature of the at least one sample arranged in the rotor can be changed, adjusted, controlled and/or regulated. With preference, the laboratory centrifuge, in particular the treatment device of the laboratory centrifuge, has a timer, with which temporal parameters of the rotation or temperature setting can be controlled. A centrifuge can perform a separation process in which in particular the constituents of suspensions, emulsions and/or gas mixtures can be separated. The device-controlled treatment of the at least one laboratory sample corresponds in a laboratory centrifuge to a rotational treatment to which the at least one sample is subjected. Possible parameters, in particular program parameters, in particular user parameters, which are used for influencing a rotational treatment, define in particular a temperature of the laboratory centrifuge, a rotation speed of the laboratory centrifuge, a temporal parameter of the rotation or temperature setting and/or at least one sequence parameter, which influences or defines the sequence, in particular the order, of a rotation program consisting of multiple rotation steps. The temperature of the laboratory centrifuge can in particular be at least one temperature inside the at least one rotor, in particular at least one temperature of at least one sample.

Different units of the centrifuge need electrical energy during operation of the centrifuge, in particular at least one drive motor of the rotor, and - if present - a cooling and/or heating device, at least one fan, at least one sensor (such as for example for measuring an operating parameter and/or for detecting an operating state, such as for example “closed centrifuge cover”), display and/or signalling devices (such as e.g. a display device for displaying the rotor speed, the temperature in the interior the centrifuge, the sample temperature and/or further operating parameters and a warning device for signalling certain events, for instance the end of the centrifuging process or at least one operating parameter leaving a target value range), at least one motor for generating a mechanical movement (such as e.g. a motorised or motor-assisted movement of a centrifuge cover, in particular for opening and/or closing the cover) and/or at least one relay for generating a magnetic field (for example to lock a fastener of the centrifuge cover). As a rule, at least one of the units to be supplied with electrical power is equipped and/or combined with an electronic controller. For example, the at least one drive motor requires a speed controller and/or a process controller for the centrifuging process, the cooling and/or heating device require a temperature controller and/or temperature regulator, the display and/or signalling devices require a logic unit and e.g. a display controller, each motor requires a motor controller. Furthermore, the centrifuge advantageously has at least one computer integrated in the centrifuge housing and/or at least one program logic unit for a superordinate control and/or monitoring of the operation of a multiplicity of units to be supplied with electrical power. The superordinate operation controller also includes in particular any logic and/or intelligence related to the operation of the centrifuge, such as a computer that allows a user or a centrifuge-external computer to influence the operation of the centrifuge.

Expediently, electrical functions (such as supplying at least one unit of the centrifuge with electrical power, including switching the supply on and/or off) and/or electronic functions, such as open-loop and closed-loop controllers and/or program logic of individual devices and/or superordinate operation controllers, are realised at least partially by components which are combined to form an electric and/or electronic unit (abbreviated to “electronic unit” hereinafter. Such an electronic unit is often realised by means of at least one circuit board which carries and electrically connects the electrical and/or electronic component, wherein optionally at least one of the components can be integrated in the circuit board. Such a circuit board is also referred to as a printed circuit board (PCB) if it has printed circuit components, as is typical. The electronic unit can comprise such a circuit board or a plurality of such circuit boards, which are connected to one another at least mechanically and optionally also electrically by electrical lines of the electronic unit. However, it is also possible for a centrifuge to have a plurality of such electronic units, which are mechanically separate from one another and are only connected to one another via the centrifuge housing and/or connecting parts in the interior of the housing, for example. In particular, such separate electronic units can be installed and/or replaced independently of one another as part of the centrifuge. In particular, each of these separate electronic units has at least one circuit board. An electronic unit can therefore in particular be introduced into the centrifuge as an entire unit and taken out of it again, wherein, when (i.e. during) and/or after introducing the electronic unit into the centrifuge, typically at least one electrical connection to at least one other unit of the centrifuge needs to be established and, before and/or during removal, the at least one electrical connection needs to be disconnected again. Such an at least one electrical connection can be produced by at least one cable and/or at least one plug connector, for example.

Electronic units should make diagnosis of a fault possible. Alternatively or additionally, in electronic units, individual components or component parts thereof may need to be replaced, for example because they are defective and/or their intended period of use has come to an end. In addition, an electronic unit for centrifuges often has at least one electric fuse that sometimes needs to be replaced because its electrical conductor has melted, just as a fuse is intended to do in the event of excess current. Alternatively or additionally, the electronic unit can have at least one fuse that can be restored to the fuse state if it has fulfilled its safety function and interrupted an electrical connection. The fuse can be restored to the fuse state for example by a corresponding action to be performed on the electronic unit or also by an action to be performed outside the electronic unit. For example, it could be a thermal fuse.

Any diagnostic and replacement action can be subsumed under the term ‘servicing.’ However, a centrifuge and in particular a laboratory centrifuge should also enable servicing of other units of the centrifuge.

### SUMMARY

It is an object of the present disclosure to specify a centrifuge, in particular a laboratory centrifuge, the servicing of which is designed to be easy. Further objects are to specify a method for servicing a centrifuge and a method for producing a centrifuge that is easy to service.

A centrifuge is proposed, in particular a laboratory centrifuge, which has an electronic unit of the above-described type, wherein the centrifuge has a housing, in which the centrifuge rotor and the electronic unit are received. In particular, all of the further components of the centrifuge are also arranged in and/or on the housing, with the exception of any components such as electrical cables for supplying the centrifuge with electric power. The components in and/or on the housing can include, in particular, a drive device (with at least one drive motor) for driving a rotational movement of the centrifuge rotor, at least one heating/cooling device with which the temperature of the at least one sample arranged in the rotor can be changed, set, controlled and/or regulated, at least one fan for generating an air flow (in particular for dissipating heat from the centrifuge) and/or any combination of the components and devices mentioned in the introduction.

The centrifuge is designed in such a way that the electronic unit can be taken out of the centrifuge housing from the front side. However, later on in this description, a combination of the electronic unit with a fan is also described which may also exist if the electronic unit cannot be taken out of the centrifuge housing from the front side.

The proposed centrifuge, in particular a laboratory centrifuge, has, in the interior of a centrifuge housing, a rotor for receiving and centrifuging centrifuged material, wherein the centrifuge housing has a top side, a bottom side, a front side and a rear side, wherein the centrifuge has an electronic unit with a plurality of electronic components for realising electronic functions for operation of the centrifuge. As already mentioned, the centrifuge is designed in such a way that the electronic unit can be taken out of the centrifuge housing from the front side.

A method for servicing a centrifuge, in particular a laboratory centrifuge, has, in the interior of a centrifuge housing, a rotor for receiving and centrifuging centrifuged material, wherein the centrifuge housing has a top side, a bottom side, a front side and a rear side, and wherein the centrifuge has an electronic unit with a plurality of electronic components for realising electronic functions for operation of the centrifuge. The electronic unit is taken out of the centrifuge housing from the front side, is serviced and is reintroduced into the centrifuge housing from the front side. The electronic unit reintroduced into the centrifuge housing can be the same electronic unit or a replacement unit.

A method for producing a centrifuge, in particular a laboratory centrifuge, has the following steps:
arranging a rotor in a centrifuge housing, wherein the rotor is used to receive and centrifuge centrifuged material and wherein the centrifuge housing has a top side, a bottom side, a front side and a rear side,
arranging an electronic unit in the interior of the centrifuge housing, wherein the electronic unit has a plurality of electronic components for realising electronic functions for operation of the centrifuge.

The centrifuge is designed such that the electronic unit can be taken out of the centrifuge housing from the front side.

Advantageously the centrifuge can remain unchanged where it is installed while the electronic unit is taken out for servicing and reintroduced into the housing.

The embodiments of the centrifuge described in this description result in corresponding embodiments of the servicing method and the production method. For example, a guide for guiding a movement of the electronic unit is also described. A corresponding embodiment of the servicing method therefore has the step of guiding the electronic unit while it is moved by the guide. A corresponding embodiment of the production method includes the step of providing the guide.

As mentioned, the centrifuge housing (called ‘housing’ for short hereinafter) has a top side, a bottom side, a front side and a rear side. Although a cuboidal design of the housing with in each case a flat or approximately flat housing surface on each of the six sides is possible and is often realised in this way, the housing is not restricted to such a cuboidal design. Rather, even a non-cuboidal housing has a top side, a bottom side, a front side and a rear side, e.g. even if the housing has a round outer contour when seen from above. On the other hand, each centrifuge typically has a distinct orientation in the vertical direction. Even if the centrifuge is designed such that the rotation axis (the axis of rotation around which the centrifuge rotates) of the centrifuge rotor can be adjusted relative to the vertical, each centrifuge and above all each laboratory centrifuge typically has a certain alignment of the housing relative to the vertical. This creates the top side and the bottom side of the housing. Moreover it is generally desired that the housing of the centrifuge and in particular the laboratory centrifuge is freely accessible on one side, situated between the top side and the bottom side of the housing. This side can be referred to as front side and is characterised in many designs in that it contains control elements and/or display elements there or in any case the majority of the control elements and/or display elements or the control elements and/or display elements that are most important for a user to be able to interact with the centrifuge (in particular those that are to be operated or detected most often). Opposite the front side is the rear side, which in many case is inaccessible or difficult to access since the centrifuge is aligned with the rear side, e.g. facing a wall or another object. The designations front side and rear side mean, as already mentioned, that the housing shape is arbitrary and therefore the front housing surface is not bounded in every embodiment on the right and left by two housing corners where the front surface transitions in each case into a lateral surface, as is the case with a cuboidal design, however. If the housing has a cuboidal design, there are six sides, namely two mutually opposite lateral sides in addition to the top side and the bottom side and the front side and the rear side. In this case, the surface of the housing extends along a plane on each of the six sides and extends, in particular, substantially in this plane, wherein a curved profile of the surface with a large radius of curvature is possible and wherein at the corners, i.e. the transitions between in each case two of these six surfaces, the profile of the surface has in each case a small or very small radius of curvature (compared to the large radius of curvature).

In one embodiment of the centrifuge, the front side of the centrifuge housing has a housing cover which is designed to be movable and/or removable from other housing parts of the centrifuge housing in such a way that, when the centrifuge is covered, the cover covers a receiving space for receiving the electronic unit and, when open, allows access to the receiving space from the front side. If the housing cover is correspondingly designed to be movable, this can be a movable cover that extends over the entire front surface or that only extends over part of the front surface. For example, the entire cover can have a movable part on the front side, which in the open state, exposes a sufficiently large opening for removing the electronic unit. In any case, the movement that results in the open state can be any suitable movement, for example an unfolding movement and/or an at least partially a linear movement. However, compared to removing the cover, the degrees of freedom of the movement of the cover are restricted when the cover is moved into an open state, for example because the cover remains connected to the housing via at least one dimensionally stable and/or at least one elastically deformable element.

In accordance with a corresponding embodiment of the servicing method, the centrifuge housing has a housing cover on the front side, wherein the housing cover is opened, thereafter the electronic unit is taken out of the centrifuge housing through an opening exposed by the housing cover, wherein the electronic unit is reintroduced into the centrifuge housing through the opening and wherein the housing cover is closed (again). The electronic unit reintroduced into the centrifuge housing can be the same electronic unit or a replacement unit

The cover has the advantage, that the covered electronic unit covered by the cover is protected from external influences. The covered state of the cover can in particular be a state in which the centrifuge ready for operation, and the open state of the cover can be a state in which the centrifuge is not ready for operation, For example, operation of the centrifuge can be blocked if the cover is not closed, for example by only making it possible to switch on the power supply to the centrifuge when the cover is closed. The closed state and/or the opened state can be detected, for example, by at least one sensor that is connected to the centrifuge controller via signals.

The cover can form only a part of the front surface of the housing or alternatively the entire front surface of the housing. In the latter case, the cover can also be referred to as front or front part. Here it is optionally possible for the cover to have a cutout for example, in which a further component of the centrifuge is situated when the cover is closed, for example a display. This further component then also forms a part of the front surface of the housing. It is alternatively or additionally possible for the open cover to expose an opening which is designed to be as small as possible in order to still allow the electronic unit to be taken out of the centrifuge housing through the opening. However it is preferred if the housing cover, in the covered state, forms at least a predominant part (i.e. at least 50 per cent) of the front surface (and optionally, as mentioned, the entire front surface) of the centrifuge housing. Such a large opening has the advantage of making it easier to remove and reinsert the electronic unit and moreover a maintenance engineer can see a significant part of the housing interior. Particularly if an electrical connection to the electronic unit needs to be disconnected before and/or during the removal of the electronic unit, and vice versa if the electrical connection needs to be established while and/or after introducing the electronic unit into the housing, a large opening is an advantage.

In accordance with one refinement of the embodiment with the housing cover, the latter has at least one display device for displaying information about operation of the centrifuge and/or at least one control element for influencing at least one mode of operation of the centrifuge. As already mentioned, it is frequently the case that there is a display device and/or a control element on the front surface of a centrifuge. In particular, such a display device and/or such a control element can be connected to the electronic unit via an electrical connection (for example a cable or cable harness and/or a bus line) when the centrifuge is in the operation-ready state. In other words, this means that the electrical connection is preferably disconnected when the electronic unit is taken out of the centrifuge housing. The electrical connection can be produced e.g. via a plug connector and/or a deformable cable when the centrifuge is in its operation-ready state. A deformable cable can in particular be designed such that the electronic unit can be taken partially or completely out of the housing while it is still electrically connected to other components of the centrifuge via the cable. This allows, for example, the cable to be disconnected from the electronic unit following the partial or complete removal of the latter and/or at least one servicing step to be performed for servicing the centrifuge, during which an interaction with the partially or completely removed electronic unit takes place, during which electric currents flow through the cable and in particular signals are also transmitted.

In particular, the centrifuge can have a guide for guiding a movement of the electronic unit during which the electronic unit is taken out of the receiving space and thus out of the centrifuge housing from the front side or during which the electronic unit is introduced into the receiving space and thus into the centrifuge housing from the front side.

In this case, the guide is designed in particular such that it guides at least part of the movement, with preference a first part of the movement when the electronic unit is being taken out of the centrifuge housing. This means that another part of the movement (which, for example, completes the removal of the electronic unit from the centrifuge housing) can be carried out by the guide without specifying a movement direction. Optionally, the degrees of freedom of movement can also be restricted in this other part of the movement by the guide or by other components of the centrifuge. When performing this other part of the movement, for example a rotational movement can therefore be superimposed on a pulling movement in order to take the electronic unit out of the centrifuge housing (i.e. the electronic unit is also turned during the removal movement). Optionally, in this example the pulling movement nevertheless cannot be performed in just any forward direction, because at least one component of the centrifuge blocks the path in some of these directions. For example, the guide can therefore be designed such that starting from the completely installed state (in which in particular operation of the centrifuge is possible), the electronic unit initially only allows a linear removal movement of the electronic unit and, after this part of the removal movement has been performed, either no longer limits the further removal movement or allows movements in various directions and therefore also with superposed rotational movement.

In particular, the guide can be designed as a drawer guide, with the electronic unit being the drawer in this case. The drawer guide, as follows from the above-described variants of the removal movement, does not need to be designed such that it guides the removal movement to complete removal of the electronic unit from the drawer housing. Since electronic unites usually only need to be taken out the centrifuge housing rarely or at relatively large intervals of time of a few weeks, months or years, the guide may be endowed with elements (for example ball-bearing rollers) for reducing the movement resistance, but this is not necessary.

Expressed more generally, the guide can be designed in accordance with one embodiment in such a way that at least part of the movement for taking out the electronic unit is a linear pulling movement. Such a movement is clearly defined, is easy to perform, and in particular allows the electronic unit to be brought partially or completely out of the housing on the shortest path possible.

In each embodiment, a guide has the advantages that the removal movement is specified and thus facilitated and that the electronic unit can be prevented from colliding with components of the centrifuge that need to be protected by an appropriate embodiment of the guide.

In particular, the guide can be formed at least partially by a part of the centrifuge housing. By way of example, a housing bottom can form a part of the guide and/or a part of the guide can be arranged on the housing bottom. Alternatively or additionally, a side wall of the housing can form a part of the guide and/or a part of the guide can be arranged on the side wall. Also alternatively or additionally, at least one device of the centrifuge inside the housing, such as the centrifuge vessel, can form a part of the guide. It should be noted here that in particular the delimitation of the space into which the electronic unit can be introduced and from which is can be taken out constitutes a guide if, as in the case of a side wall or a bottom of the housing or also possibly in the case of the stated device in the centrifuge housing, it extends in the direction in which the electronic unit is moved when it is introduced into the housing or taken out of the latter.

In accordance with a further design, a fan is arranged on the electronic unit which, jointly with the electronic unit, can be taken out of the centrifuge housing from the front side, wherein, when the electronic unit is installed, the fan is arranged in an area that is higher or lower with respect to electronic components of the electronic unit and wherein the fan is designed to suck in air (in particular from the interior of the centrifuge housing) and to deflect and/or accelerate the air in such a way that it flows along the electronic components and/or along a carrier of the electronic components. Fans for electronic units are generally known. However, such fans are typically either arranged fastened separately from the electronic unit or arranged directly in the area of the electronics components. By contrast, in the embodiment proposed herein, the fan is located at a different height level.

Often, in particular when the electronic unit has a circuit board (or in the case of multiple circuit boards, a main board), the electronics components or at least a predominant part of the electronics components are arranged in a common assembly plane. This means of course that the electronics components may have differently sized dimensions and therefore, for example, end at different distances from the circuit board surface. The assembly plane may therefore for example be the plane of the surface of the circuit board or a notional plane, which penetrates the electronics components. Such an electronic unit allows in principle assembly in any desired assembly plane. The options for assembly are therefore not restricted to aligning the assembly plane horizontally. Expressed more generally, the fan can therefore be arranged offset with respect to the assembly plane and fastened to the electronic unit. Such an offset arrangement of the fan has the advantage that the fan, which usually has larger dimensions than the individual electronic components, can be arranged in a suitable larger space in the centrifuge, while the entire electronic unit usually extends over a greater length in a longitudinal direction of the electronic unit than the fan. Particularly if the fan is arranged on the front side of the arrangement consisting of electronic unit and fan, the fan can be arranged in the centrifuge in a particularly space-saving manner. In other words, the fan is then situated directly behind the front surface of the centrifuge, for example behind a removable front, while the electronic unit extends deeper into the interior of the centrifuge housing. This moreover has the advantage that air flow sucked in by the fan can be guided along one side from the front of the centrifuge housing and can also for example be deflected from the front in the desired flow direction of the fan. Optionally, at the same time, the front can be cooled by the air flow on its housing inner side, e.g. if there is at least one display element in this area of the front.

Particularly if the assembly plane is therefore horizonal when the electronic unit is installed, the fan can be arranged above a front area of the electronic unit and then has the stated advantages.

Alternatively or additionally, when the electronic unit is installed and during operation of the fan, the fan can deflect and/or accelerate the air such that it firstly flows along the electronic components and then flows along a motor for driving a rotational motion of the rotor along. In this case, the fan is at least involved in cooling the motor. This makes it possible, in particular, to arrange the motor behind the electronic unit as seen from the front side.

### BRIEF DESCRIPTION OF THE DRAWINGS

Exemplary embodiments of the invention will now be described with reference to the appended drawing.

FIG. 1 shows schematically, a vertical section through an embodiment of a laboratory centrifuge, wherein at the bottom left in the figure an area is outlined with a dashed line and designated II, which is enlarged in FIG. 2.

FIG. 2 shows the enlarged area from FIG. 1.

FIG. 3 shows a perspective illustration of a further laboratory centrifuge, wherein identical or functionally identical parts to those in FIG. 1 have been given the same reference designations.

FIG. 4 shows a perspective illustration as in FIG. 3, although fewer parts of the laboratory are shown compared to FIG. 3.

FIG. 5 shows a perspective illustration as in FIG. 4, although even fewer parts of the laboratory centrifuge are shown compared to FIG. 3.

FIG. 6 shows a part of the electronic unit exemplary embodiment of the laboratory centrifuge from FIG. 3 to FIG. 5.

FIG. 7 shows a laboratory centrifuge with a housing and a housing cover in the state where the housing cover has not been removed from the housing.

### DETAILED DESCRIPTION

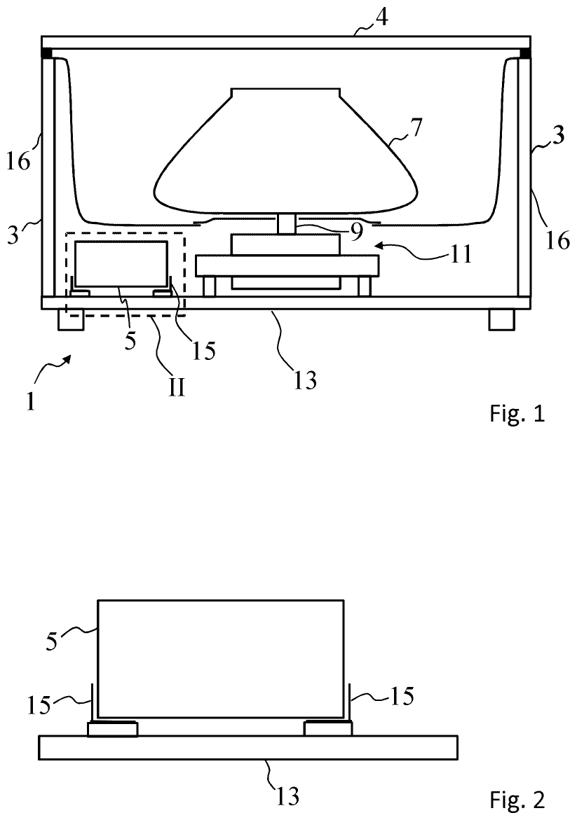

The laboratory centrifuge 1 shown in FIG. 1 has a housing 3 with side walls 16, a bottom 13 and a cover part 4. For example, the cover part 4 can have a cover that can be opened and closed. Located inside the housing 3 is a rotor 7 that rotates during operation of the laboratory centrifuge 1 via a motor shaft 9 driven by a drive 11. The corresponding rotation axis runs in FIG. 1 in the vertical direction through the centre of the schematically shown motor shaft 9 and is not shown. The rotor 7 is used to receive the sample or the samples that are to be centrifuged.

An electronic unit 5 can be seen in the enlarged illustration of the area at the bottom left in FIG. 1, which is shown in FIG. 2. Also schematically shown are guides 15 which guide a movement of the electronic unit 5 forwards out of the housing 3. The electronic unit 5 is thus embodied as a type of drawer. In particular, the representation of parts of the centrifuge 1 in FIG. 1 can be understood as a view from the front, in which a front cover of the centrifuge 1 has been removed and only a selection of parts is shown. The electronic unit 5 is then situated front left in the housing 3 of the centrifuge 1.

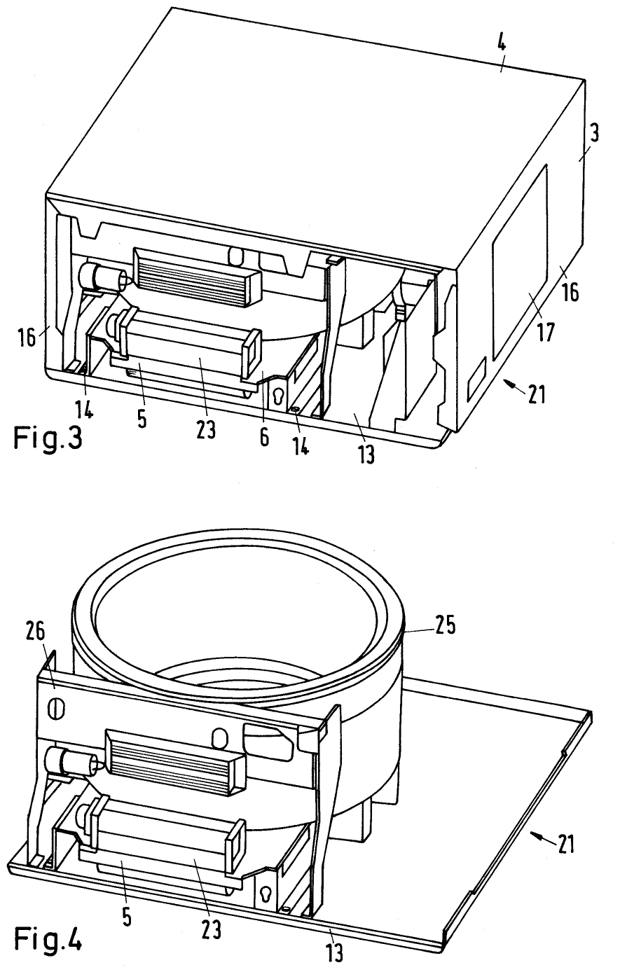

Numerous modifications to the arrangement in FIG. 1 are possible. For example, the electronic unit, as is explained in more detail with reference to FIGS. 3 to 6, can be arranged in front of the drive 11 of the rotor 7, as seen from the front (the front side). Furthermore, the dimensions of the parts of the centrifuge 1 shown in FIG. 1 can be chosen to be different. The illustration in FIG. 1 is to be understood to be schematic in this respect. Guides such as the guides 15 shown in FIG. 1 for guiding the movement of the electronic unit when taking it out of the housing of the centrifuge are not absolutely necessary. Since the removal is typically performed by trained maintenance engineers, the electronic unit can also be taken out of the housing without such guides, for example after removing the front cover.

The housing 3 of the laboratory centrifuge 21 shown in FIG. 3 is a concrete embodiment of the housing 3 from FIG. 1. For example, it has an air passage opening 17 on the right-hand side wall 16. At least one air passage opening can also be located in the opposite side wall 16, of which only the front edge with a fastening plate arranged there can be seen in FIG. 3. In particular, air enters the interior of the housing 3 through the air passage opening 17 that can be seen on the right in FIG. 3 during the operation of the laboratory centrifuge 21 and heated air exits through the at least one air passage opening in the side wall shown on the left in FIG. 3.

The front cover the housing 3 is not shown in FIG. 3, thus showing a view of the front area of the housing interior. In particular an electronic unit 5 with a cross-flow fan 23 arranged thereon can be seen. The electronic unit 5 is fastened to the bottom 13 of the housing 3, for example with two screws 14, which, after removal of the front cover, in each case connect a fastening section of the electronic unit 5 to the bottom 13 in an area of the housing 3 that can easily be accessed by the service engineer. However, it is alternatively conceivable that the electronic unit, in another design of a centrifuge, is fastened to the front cover and is taken out of the housing by removing the front cover.

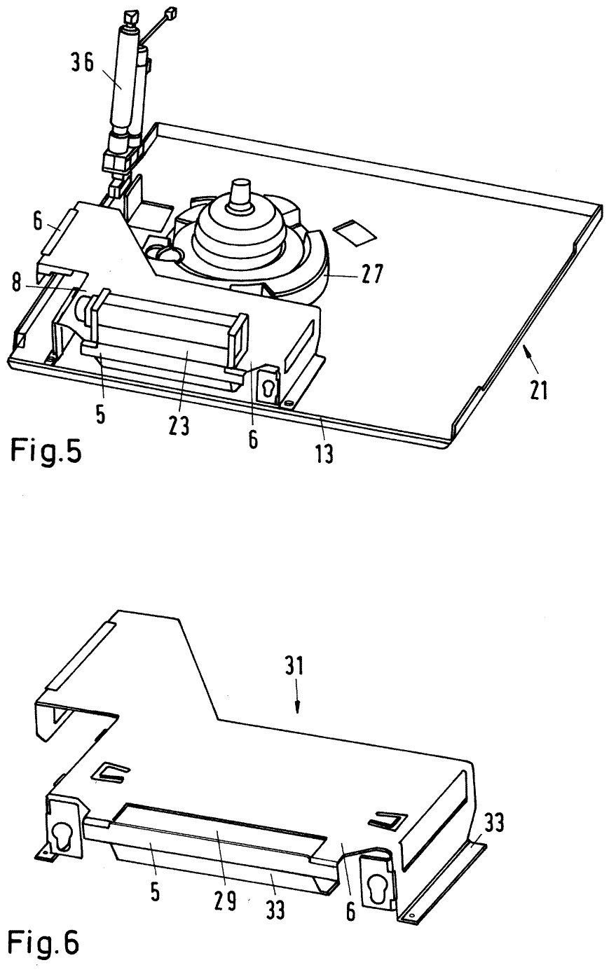

FIG. 4 shows, as mentioned, fewer parts of the centrifuge than FIG. 3. In particular, with the exception of the bottom 13, all other parts of the housing 3 have been omitted. Also, in particular in the right and rear parts of the centrifuge 21, most of the parts are not shown in FIG. 4 and FIG. 5. However, a fastening device 26 for fastening and/or for supporting the cover part 4 and a rotor guard ring 25 can be seen in FIG. 4. During operation of the centrifuge 21, the rotor rotates in the interior of the guard ring 25. The further reduced illustration in FIG. 5 shows a pneumatic spring 36 in an area to the left behind the electronic unit 5 and also to the left behind the rotor guard ring 25, which spring serves to assist with the opening and closing of a cover of the housing 3.

The abovementioned cross-flow fan 23 is arranged above the area in which an arrangement (not shown in the figures) of electronic components and/or electrical components of the electronic unit 5 is located, for example in which there is a circuit board with these components. Apart from the cross-flow fan 23, in FIGS. 3 to 6 of the electronic unit 5 only a mount 6 can be seen, which is fastened to the bottom 13, for example via the abovementioned screws 14. The cross-flow fan 23 rests on an upper surface of a plate-shaped area 8 of the mount 6. As can be seen from the representation in FIG. 5 and FIG. 6, the plate-shaped area 8 ends at the rear left in an area that can be fastened to the left side wall 16 of the housing 3. In the area of the mount 6, the left side wall 16 shown in FIG. 3 shown, but omitted in FIGS. 4 and 5, forms a guide for guiding the movement of the electronic unit 5 when the latter is taken out of the housing 3 or is introduced into the housing 3. Similarly, in the exemplary embodiment shown in FIG. 3 to FIG. 5, the bottom of the housing 3 forms a guide for this movement. In particular it is therefore easy to reach a position in which the electronic unit 5 is screwed to the bottom, for example.

Located on the bottom side, i.e. on the lower surface of the plate-shaped area 8, is for example the abovementioned circuit board with the stated components, or the abovementioned components are fastened there in some other way. Just like the plate-shaped area 8, this upper surface extends in a horizontal direction. In this case, the rotation axis of the rotational movement of the fan rotor, through which the air is sucked in and accelerated, also extends in a horizontal direction and, in the concrete exemplary embodiment, parallel to the surface of the laboratory centrifuge 21 at its front side. Since the front cover is not shown, the front surface can be imagined as a flat surface which extends along the front edge of the bottom 13 and moreover extends in a vertical direction. In the illustration in FIGS. 3 to 6, during operation of the centrifuge, the cross-flow fan 23 sucks in air from the interior of the housing 3, which, for example, enters the housing 3 at least partially through the air passage opening 17 on the right side shown in FIG. 3, accelerates this air and blows it downwards through the recess 29 of the mount 6 that can be seen in FIG. 6. In the concrete embodiment in FIGS. 3 to 6, there is an air baffle 33 on the front edge of the mount 6, which air baffle deflects the air blown by the cross-flow fan 23 through the recess 29 in an air flow which moves on the bottom side of the plate-shaped area 8 away from the front side of the centrifuge 21, i.e. to the rear. As can best be seen in FIG. 5, the drive motor 27 of the drive for the rotational movement of the rotor of the centrifuge is located behind the electronic unit 5. Therefore, the air flow generated by the cross-flow fan 23 not only cools the electronic components and/or electrical components of the electronic unit 5 that are located below the plate-shaped area 8 but also the drive motor 27. In particular, the air flow can then escape through the abovementioned at least one air-outlet opening of the housing, for example in the side wall 16 arranged on the left in FIG. 3.

The above-described exemplary embodiment has the following features, which can also be found in other designs of a centrifuge, in particular a laboratory centrifuge: located on a first side of a mount of the electronic unit are electronic components and/or electrical components of the electronic unit. A fan is arranged on a second side, opposite the first side, of the mount, which fan sucks in the air from the interior of the centrifuge and blows it out though an opening and/or recess in the mount. The air flow generated by the fan cools the components arranged on the second side of the mount during the operation of the centrifuge. With preference, there is also a drive motor for the centrifuge rotor in the air flow that cools these components during operation of the centrifuge. After this air flow has cooled the components, it reaches the drive motor and also cools the latter. In this case, the arrangement does not have to be as shown in FIG. 5, for example. Rather, the air flow generated by the fan can, for example with reference to the illustration of the laboratory centrifuge 21 in FIG. 3, firstly cool the stated components of the electronic unit and then be deflected again in order to flow in a direction in which the air flow reaches the drive motor. For example, with reference to FIG. 5, the fan could therefore generate an air flow which, due to a corresponding arrangement of the fan and optionally also an air baffle, flows in a direction approximately parallel to the front surface of the centrifuge and is then deflected in the direction of the drive motor. Therefore, the electronic components and/or electrical components do not necessarily have to be arranged behind the electronic unit, as seen from the front side of the centrifuge.

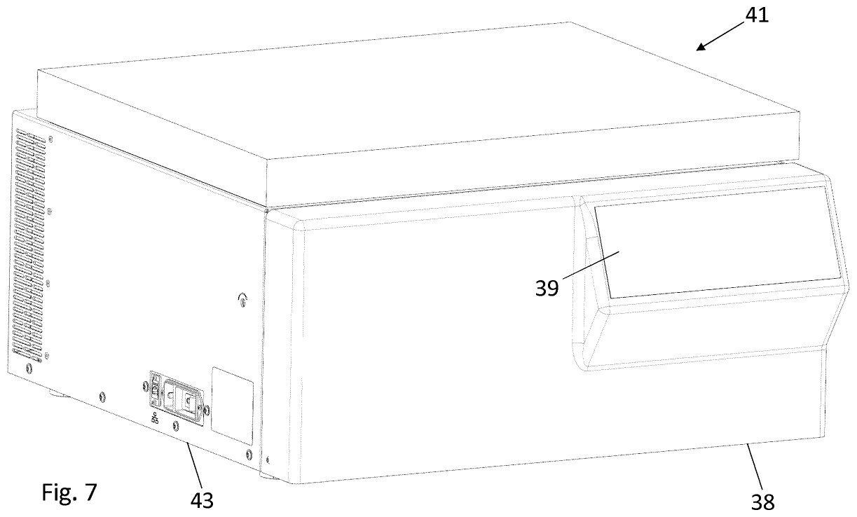

FIG. 7 shows a laboratory centrifuge 41, which may be a concrete embodiment of the laboratory centrifuge shown in FIG. 1 and/or FIG. 3. Only the centrifuge housing 43 with the housing cover 38 arranged on the front side can be seen in FIG. 7. The housing cover 38 is designed to be movable and/or removable from a main part of the centrifuge housing 43 in such a way that it covers the receiving space (not visible in FIG. 7) for receiving the electronic unit. In an open state not shown in FIG. 7, the housing cover 38 allows access to the receiving space from the front side, so that in this state the electronic unit can then be taken out of the main part of the centrifuge housing 43. The housing cover 38 forms, in the covered state shown in FIG. 7, a predominant part of the front surface of the centrifuge housing 43. In this case, the housing cover 38 extends over the entire width of the laboratory centrifuge 41. However, the upper area of the main part of the centrifuge housing 43 is located above the height level of the upper edge of the housing cover 38, so that this upper area also forms a part of the front surface of the centrifuge housing 43. In the concrete exemplary embodiment shown, the front surface at the upper edge of the housing cover 38 juts back, i.e. the subsection of the front surface formed by the upper area of the main part of the centrifuge housing 43 lies behind the subsection of the front surface formed by the housing cover 38.

The housing cover 38 has a display device 39 for displaying information about operation of the laboratory centrifuge 41. Optionally, the upwardly obliquely aligned surface of the display device 39 shown in FIG. 7 is designed as a touch-sensitive element, so that at least one mode of operation of the laboratory centrifuge 41 can be influenced by controlled by touch.

### LIST OF REFERENCE DESIGNATIONS

1 laboratory centrifuge
3 housing
4 cover part
5 electronic unit
6 mount
7 rotor
8 plate-shaped area
9 motor shaft
11 drive
13 bottom
14 screw
15 guide
16 side wall
17 air-passage opening
21 laboratory centrifuge
23 cross-flow fan
25 rotor-guard ring
26 fastening device for cover part
27 drive motor
29 recess for cross-flow fan
31 air outlet area
33 air baffle
36 pneumatic spring
38 housing cover
39 display device
41 laboratory centrifuge
43 centrifuge housing

1. A centrifuge (1; 21), comprising:
a centrifuge housing (3) having a top side, a bottom side, a front side, and a rear side;
a rotor (7) for receiving and centrifuging centrifuged material disposed in an interior of the centrifuge housing (3); and
an electronic unit (5) with a plurality of electronic components for realising electronic functions for operation of the centrifuge,
wherein the electronic unit (5) can be taken out of the centrifuge housing (3) from the front side.

2. The centrifuge (1; 21) according to claim 1,
wherein the front side of the centrifuge housing (3) has a housing cover (38), and
wherein the housing cover (38) is movable and/or removable from other housing parts of the centrifuge housing (3) such that, when the centrifuge is covered, the housing cover (38) covers a receiving space for receiving the electronic unit (5) and, when open, allows access to the receiving space from the front side.

3. The centrifuge (1; 21) according to claim 2,
wherein the housing cover (38) has at least one display device (39) for displaying information about operation of the centrifuge and/or at least one control element for influencing at least one mode of operation of the centrifuge.

4. The centrifuge (1; 21) according to claim 2,
wherein the housing cover (38) in a covered state forms at least a predominant part of a front surface of the centrifuge housing (3).

5. The centrifuge (1; 21) according to claim 1,
wherein the centrifuge has a guide (15) for guiding a movement of the electronic unit (5) during which the electronic unit (5) is taken out of a receiving space and thus out of the centrifuge housing (3) from the front side or during which the electronic unit (5) is introduced into the receiving space and thus into the centrifuge housing (3) from the front side.

6. The centrifuge (1; 21) according to claim 5,
wherein the guide (15) is designed in such a way that at least part of the movement for taking out the electronic unit (5) is a linear pulling movement.

7. The centrifuge (1; 21) according to claim 1,
wherein a fan (23) is arranged on the electronic unit (5) which, jointly with the electronic unit (5), can be taken out of the centrifuge housing (3) from the front side, wherein, when the electronic unit (5) is installed, the fan (23) is arranged in an area that is higher or lower with respect to electronic components of the electronic unit (5) and wherein the fan (23) is designed to suck in air and deflect and/or accelerate the air in such a way that it flows along the electronic components and/or along a carrier of the electronic components.

8. The centrifuge (1; 21) according to claim 7,
wherein, when the electronic unit (5) is installed, the fan (23) is arranged above a front area of the electronic unit (5).

9. The centrifuge (1; 21) according to claim 7,
wherein, when the electronic unit (5) is installed and during operation of the fan (23), the fan (23) deflects and/or accelerates the air in such a way that it firstly flows along the electronic components and then flows along a motor

(27) for driving rotational movement of the rotor (7).

10. A method for servicing a centrifuge (1; 21) having
a centrifuge housing (3) with a top side, a bottom side, a front side, and a rear side,
a rotor (7) for receiving and centrifuging centrifuged material disposed in an interior of the centrifuge housing (3), and
an electronic unit (5) with a plurality of electronic components for realising electronic functions for operation of the centrifuge,
the method comprising:
taking the electronic unit (5) out of the centrifuge housing (3) from the front side;
servicing the electronic unit (5); and
reintroducing the electronic unit (5) into the centrifuge housing (3) from the front side.

11. The method according to claim 10,
wherein the centrifuge housing (3) has a housing cover (38) on the front side, and wherein the method further comprises:
opening the housing cover (38);
taking the electronic unit (5) out of the centrifuge housing (3) through an opening that has been exposed by the housing cover (38);
reintroducing the electronic unit (5) into the centrifuge housing (3) through the opening; and
closing the housing cover (38).

12. A method for producing a laboratory centrifuge (1; 21), comprising:
arranging a rotor (7) in a centrifuge housing (3),
wherein the rotor (7) is configured to receive and centrifuge centrifuged material, and
wherein the centrifuge housing (3) has a top side, a bottom side, a front side and a rear side; and
arranging an electronic unit (5) in an interior of the centrifuge housing (3), wherein the electronic unit (5) has a plurality of electronic components for realising electronic functions for operation of the centrifuge,
wherein the centrifuge is designed such that the electronic unit (5) can be taken out of the centrifuge housing (3) from the front side.
